(19) United States
(12) Patent Application Publication
(10) Pub. No.: US 2016/0160840 A1
(43) Pub. Date: Jun. 9, 2016

(54) HYDRAULIC PITCH SYSTEM UTILIZING PILOT PRESSURED RESERVOIR FOR WIND TURBINES

(71) Applicant: HYDRATECH INDUSTRIES WING POWER A/S, Silkeborg (DK)

(72) Inventors: Jens Bay MADSEN, Aarhus C (DK); Soren STUBKIER, Silkeborg (DK)

(21) Appl. No.: 14/906,091

(22) PCT Filed: Jul. 9, 2014
(86) PCT No.: PCT/DK2014/050214

§ 371 Date: Jan. 19, 2016

(30) Foreign Application Priority Data
Aug. 1, 2013 (DK) PA 2013 00448

(51) Int. Cl. F03D 7/02

(52) U.S. Cl. CPC F03D 7/0224

(57) ABSTRACT

Disclosed is a fluid control system for operation of a pitch control system for wind turbines of the type comprising a pitch system driving at least one rotor blade, by at least one hydraulic actuator (1, 41, 51, 61, 71, 91). A hydraulic pump(3, 43, 53, 63, 73, 93)of the fluid control system is supplied with hydraulic fluid from a hydraulic reservoir (5, 45, 55, 65, 75, 95) mounted on a rotating part of the wind turbine and the hydraulic reservoir is a pilot pressurized hydraulic reservoir (5, 45, 55, 65, 75, 95) being pressurized by the pitch system itself. The pilot pressurized hydraulic reservoir (5, 45, 55, 65, 75, 95) comprises a reservoir piston(101, 200)connected to a pilot piston (105, 202) through a rod (103), wherein the active reservoir piston area of the reservoir piston(101, 200) is larger than the active pilot piston area of the pilot piston (105, 202). A wind power generator is also disclosed.

### FIELD OF THE INVENTION

The present invention relates to a fluid control system for operation of a pitch control system for wind turbines of the type comprising a pitch system driving at least one rotor blade, by at least one hydraulic actuator. The invention further relates to a wind power generator equipped with the fluid control system.

### BACKGROUND OF THE INVENTION

Standard wind turbines utilize pitch systems for turning the rotor blades. The rotor blades are turned in order to change the amount of energy extracted from the wind hence optimizing the power production. Further, the pitch system is the single most important safety system of a wind turbine, turning the blades to a predefined position, where no energy is extracted from the wind.

This invention relates to hydraulic pitch systems. Normal hydraulic pitch systems turn the blades of the wind turbine by usage of one or more linear hydraulic cylinders per blade. The hydraulic cylinders are placed in the rotating hub of the turbine. The hydraulic cylinders are actuated by supplying pressurized hydraulic fluid on either the piston side or rod side of the cylinder, depending on the desired direction of movement.

The pressurized hydraulic fluid is supplied from a power pack compromising a tank, pump and electrical motor. Due to the current design of the tank the power pack is placed in the nacelle of the wind turbine. This means that the pressurized hydraulic fluid must be transferred from the stationary part of the turbine to the rotating hub. This is normally done by utilization of a hydraulic slip ring, or rotary union, which is able to send the hydraulic fluid back and forth from the rotating hub.

It would be an advantage to move the entire pitch system to the rotating hub, minimizing the risk of hydraulic leakage, the cost of the pitch system and the distribution of the pitch system in the turbine.

Several issues must be dealt with before it is possible to move the entire hydraulic pitch system into the rotating hub. The biggest issue is however how to store the hydraulic fluid in the rotating hub. The volume of oil in the tank is variable depending on system condition, e.g. how far is the cylinder elongated and how much oil is in the hydraulic accumulators along with the system temperature. Hence the tank volume must be variable. Also, the rotating tank may not mix oil and air, be non-leaking and able to operate being turned 360 degrees up and down.

Several concepts have been disclosed in patent applications, such as U.S. Pat. No 7,658,594, WO03091577 and US2012/0134827 A1, but none of the solutions has ever been successfully implemented.

### OBJECT OF THE INVENTION

On that background it is an object of the invention to provide a new and more reliable technique for storing hydraulic fluid for utilization in a pitch system in the hub of a wind turbine.

### DESCRIPTION OF THE INVENTION

The invention provides for a fluid control system for operation of a pitch control system for wind turbines of the type comprising a pitch system driving at least one rotor blade, by at least one hydraulic actuator. A hydraulic pump of the fluid control system is supplied with hydraulic fluid from a hydraulic reservoir mounted on a rotating part of the wind turbine and the hydraulic reservoir is a pilot pressurized hydraulic reservoir being pressurized by the pitch system itself. The pilot pressurized hydraulic reservoir comprises a reservoir piston connected to a pilot piston through a rod, wherein the active reservoir piston area of the reservoir piston is larger than the active pilot piston area of the pilot piston.

The present invention has been made to solve the above problems, and as a result thereof provide a hydraulic pitch system, where all the parts, including the hydraulic reservoir may be placed in or on a rotating part of a wind turbine such as the rotating hub.

The present invention provides the following solution to achieve the above objects:

The hydraulic fluid must be encapsulated in a leakage free reservoir with no contact to the surrounding atmosphere and variable volume. The volume changes depending on the amount of hydraulic fluid used in the pitch actuators and stored in the hydraulic accumulators. The pump which supplies the pitch system with pressurized hydraulic fluid from the reservoir is not capable to operate properly if the supply pressure for the suction side of the pump drops below approx. atmospheric pressure. Hence the pressure on the suction side of the pump must be kept above this level.

One way of doing this is by storing the hydraulic fluid in a reservoir designed like a hydraulic accumulator- spring-, mass- or gas-loaded. The most obvious would be a gas loaded accumulator, since this is standard within the wind turbine industry and is able to operate under rotation of 360 degrees. Such a system is known from WO 02/48545 A1. However, the gas loaded accumulator is not able to supply constant pressure independent of the amount of oil encapsulated in the hydraulic accumulator. The pressure will rise exponential with the amount of oil stored in the accumulator. As oil has to return to the pressurized reservoir during e.g. an emergency stop, where the hydraulic actuator is elongated to its full length and the hydraulic accumulators dedicated for emergency stop is emptied, an increase in reservoir pressure will lead to extensive loss of available pitching force.

What would be desirable is a relatively constant reservoir pressure during operation such that the pump pressure on the suction side never drops below atmospheric pressure.

Having a pressurized reservoir without any air makes it possible to rotate 360 degrees without having the pump sucking in air or foaming of the oil.

US2012/0134827 A1 suggests controlling the pressure in the reservoir by a controllable capacity changing mechanism based on a feedback measurement from the suction side of the hydraulic pump.

The present invention is on the contrary based on a passive system without any control loop. The pressure in the reservoir is instead based on the hydraulic pressure in the pitch system itself.

Designing the reservoir in such a manner that the active reservoir piston area of the reservoir piston is larger than the active pilot piston area of the pilot piston of the pilot pressurized hydraulic reservoir i.e. the movable parts has an area ratio of for example 1:200 between the reservoir side and the pilot side will result in a reservoir pressure of 1 bar when the system pilot pressure is 200 bar. Hence, connecting the pilot side of the reservoir to the high pressure in the pitch system will lead to a reservoir pressure at a well-defined level relative to the system pressure without any control necessary.

In an embodiment the pilot pressure is coming from the fluid side of a hydraulic accumulator used to store pressurized hydraulic fluid for an emergency stop function. In an embodiment the pilot pressure is coming from the gas side of a hydraulic accumulator used to store pressurized hydraulic fluid for an emergency stop function. In an embodiment the pilot pressure is coming from a hydraulic accumulator only used for pressurizing the pressurized reservoir, hence the pressure source of the system is no longer supplying the pressure for the system and the hydraulic reservoir is pressurized even when the pressure source is not active.

The pressurized reservoir is described in U.S. Pat. No. 4,691,739 and U.S. Pat. No. 4,538,972, but in both references the pilot pressure is supplied from the pressure source of the system. Utilizing the reservoir in combination with an accumulator instead of a pressure source enables the possibility to maintain pressure even when the pressure source is not working, gives a huge advantages in having the reservoir pressurized at all times.

In an embodiment the pilot pressure is coming from a pressurized gas reservoir, which simplifies the system further, reducing the number of movable parts.

In an embodiment the pilot pressure is coming from an auxiliary function.

In an embodiment the pilot pressure is coming from the supply source of the system, preferably a hydraulic pump.

In this invention “pilot pressure” is defined as a pressure already present in the system, in e.g. a pressurized accumulator or pressure made by the pressure source of the system. By using the present pressure it is possible to lower or raise it to a desired level by utilization of a piston with two different areas.

In an aspect the pilot pressure for pressurizing the pilot pressurized hydraulic reservoir is connected to the fluid side of a hydraulic accumulator.

In an aspect the pilot pressure for pressurizing the pilot pressurized hydraulic reservoir is connected to the gas side of a hydraulic accumulator.

In an aspect the pilot pressure for pressurizing the pilot pressurized hydraulic reservoir is connected to a pressurized gas vessel.

In an aspect the pilot pressure for pressurizing the pilot pressurized hydraulic reservoir is connected to any pressurized system in the wind turbine.

In an aspect the hydraulic actuator, the hydraulic pump and the pilot pressurized hydraulic reservoir are all accommodated in the hub of the wind turbine.

In an aspect said pilot pressurized hydraulic reservoir is pressurized by the pitch system itself by utilization of a piston with a different area acting on the usable volume and the pilot volume, such that no external pressure control unit is needed.

In an aspect said rotating part of the wind turbine is a hub or a blade of said wind turbine.

In an aspect said hydraulic reservoir is placed in said rotating part of the wind turbine.

In an aspect the active reservoir piston area of said reservoir piston is between 20 and 1000, preferably between 100 and 600, and most preferred between 150 and 400 times larger than the active pilot piston area of said pilot piston.

If the active reservoir piston area of the reservoir piston is too large in relation to the active pilot piston area of the pilot piston the risk of air being mixed with the hydraulic fluid is increased. However, if this ratio is to little the pilot pressurized hydraulic reservoir will be too sensitive to the specific pilot pressure. Thus, the present piston size ratios present an advantageous relationship between safety and functionality.

In an aspect the active reservoir piston area is arranged on the side of said reservoir piston to which said rod is connected and in an aspect the active pilot piston area is arranged on the side of said pilot piston to which said rod is connected.

Forming the pilot pressurized hydraulic reservoir so that the active areas of the reservoir piston and the pilot piston are the sides to which the piston rod is connected is advantageous in that the piston rod will take up a relatively large part of the active side of the pilot piston compared to on the active side of the reservoir piston, thus making it easier to increase the size ratio between the active reservoir piston area and the active pilot piston area.

The invention further provides for a wind power generator equipped with the fluid control system according to any of the previously discussed fluid control systems for pitching a wind turbine rotor blade.

Using a fluid control system according to the present invention for pitching a blade of a wind turbine is advantageous in that this fluid control system will operate properly even if mounted on the rotor of a the wind turbine thus, mechanically sensitive parts —such as rotating unions—for transferring pressurised hydraulic fluid between stationary and rotating parts of the wind turbine can be avoided.

### DESCRIPTION OF THE DRAWINGS

In the following the invention is described in more detail with reference to the drawing in which:

FIG. 1 shows a diagram for an embodiment of a hydraulic pitch system, where the pilot pressurized hydraulic reservoir is pressurized by a hydraulic accumulator,

FIG. 2 shows a schematic of a pilot pressurized reservoir according to the invention,

FIG. 3 shows a schematic of a second embodiment of a pilot pressurized reservoir,

FIG. 4 shows a diagram for an embodiment of a hydraulic pitch system, where the pilot pressurized hydraulic reservoir is pressurized by the gas of a hydraulic accumulator,

FIG. 5 shows a diagram for an embodiment of a hydraulic pitch system where the pilot pressurized hydraulic reservoir is pressurized by a dedicated hydraulic accumulator,

FIG. 6 shows a diagram for an embodiment of a hydraulic pitch system where the pilot pressurized hydraulic reservoir is pressurized be a dedicated pressurized gas vessel,

FIG. 7 shows a diagram for an embodiment of a hydraulic pitch system, where the pilot pressurized hydraulic reservoir is pressurized by the gas pressure from a gas volume incorporated in the reservoir, and

FIG. 8 shows a diagram for an embodiment of a hydraulic pitch system, where the pilot pressurized hydraulic reservoir is pressurized by a fluid or gas pressure from another pressurized system in the wind turbine.

### DETAILED DESCRIPTION OF THE INVENTION

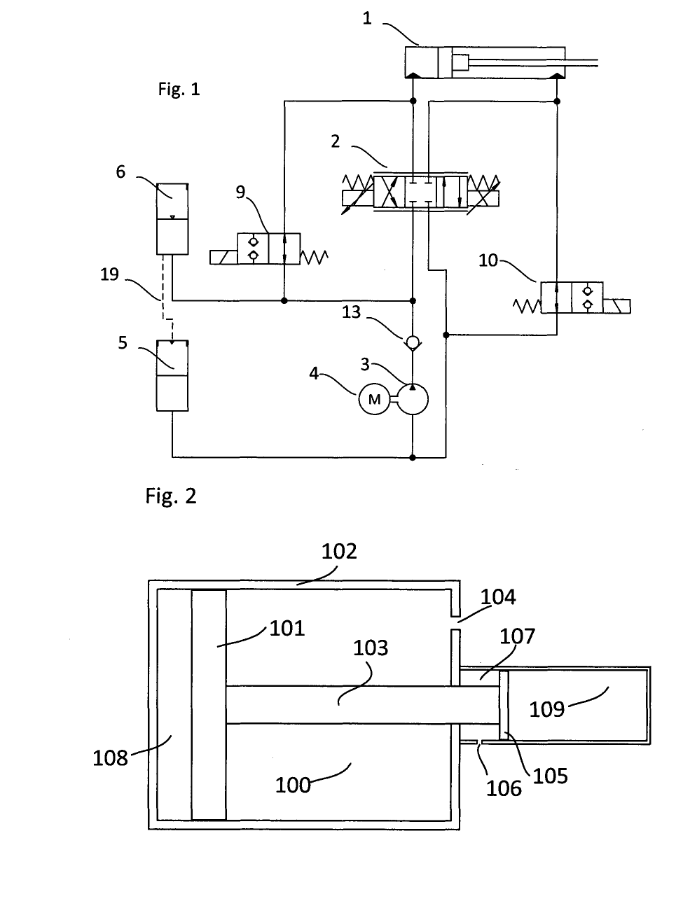

FIG. 1 shows a first schematic view of a hydraulic pitch system consisting of a pitch actuator 1, controlled by a hydraulic valve 2. The pressure and flow for control of the pitch system is delivered by the hydraulic pump 3, which is driven by the electrical motor 4. The hydraulic oil is stored in the pilot pressurized hydraulic reservoir 5. Energy for emergency stops is stored in the hydraulic accumulator 6 and lead into the pitch actuator by de-energization of valve 9. Valve 10 is used to lead the hydraulic oil from the rod side of the cylinder 1 into the pilot pressurized reservoir 5 during emergency stop. Valve 13 is a check valve. 19 illustrates the hydraulic pilot pressure line. In the schematic the line 19 is drawn from the hydraulic accumulator 6, but could have been drawn from anywhere on the high pressure side of the system. The pilot line pressure acts on the pilot area of the pilot pressurized reservoir 5 ensuring a pressure higher than atmospheric pressure.

FIG. 2 illustrates a first embodiment of the pilot pressurized reservoir, which is illustrated as 5 in FIG. 1, a vessel 102, containing the variable volume of hydraulic fluid 100, which is kept pressurized by the piston 101. The force needed for pressurizing the hydraulic reservoir 5 is transferred by the rod 103 from the pilot piston 105. The pilot pressure is led to the hydraulic volume 107 by the pilot line 106, illustrated with 19 in FIG. 1. When the pressure in 107 rises, so does the pressure in 100, but only with the ratio corresponding to the ratio between the areas of piston 101 and 105. Hence keeping a relative constant pressure in 107 will result in a relative constant pressure in 100, no matter the volume of 100 or the position of the piston 101. 104 is the connection to rest of the hydraulic system illustrated in FIG. 1 and hence, where the oil is returned from the system, but also where the hydraulic pump 3 on FIG. 1 is fed from. Notice that 109 also could be used as the pilot pressure volume, working on the piston 105, hence pressurizing the usable volume 108.

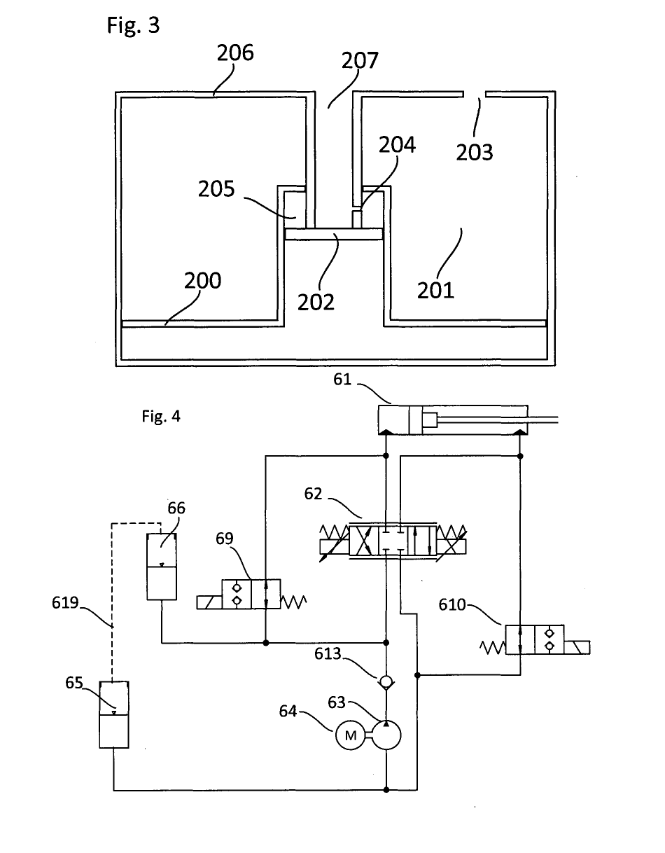

FIG. 3 illustrates a second embodiment of the pilot pressurized reservoir, which is illustrated as 5 in FIG. 1, a vessel 206, containing the variable volume of hydraulic fluid 201, which is kept pressurized by the piston 200. The force needed for pressurizing the hydraulic reservoir is transferred to the piston 202 by the pilot pressure in 205. The pilot pressure is led to the hydraulic volume 205 by the pilot line 207 and 204, illustrated with 19 in FIG. 1. When the pressure in 205 rises, so does the pressure in 201, but only with the ratio corresponding to the ratio between the areas of piston 200 and the area of the piston 202 in the pilot pressure chamber 205. Hence keeping a relative constant pressure in 205 will result in a relative constant pressure in 201, no matter the volume of 201 or the position of the piston 200. 203 is the connection to rest of the hydraulic system illustrated in FIG. 1 and hence, where the oil is returned from the system, but also where the hydraulic pump 3 on FIG. 1 is fed from.

FIG. 4 shows a second schematic view of a hydraulic pitch system consisting of a pitch actuator 61, controlled by a hydraulic valve 62. The pressure and flow for control of the pitch system is delivered by the hydraulic pump 63, which is driven by the electrical motor 64. The hydraulic oil is stored in the pilot pressurized hydraulic reservoir 65. Energy for emergency stops is stored in the hydraulic accumulator 66 and lead into the pitch actuator 61 by de-energization of valve 69. Valve 610 is used to lead the hydraulic oil from the rod side of the cylinder 1 into the pilot pressurized reservoir 5 during emergency stop. Valve 613 is a check valve. 619 illustrate the pilot pressure line. In the schematic the line is drawn from the hydraulic accumulators 66 gas side.

The pilot line pressure acts on the pilot area of the pilot pressurized reservoir 65 ensuring a pressure higher than atmospheric pressure.

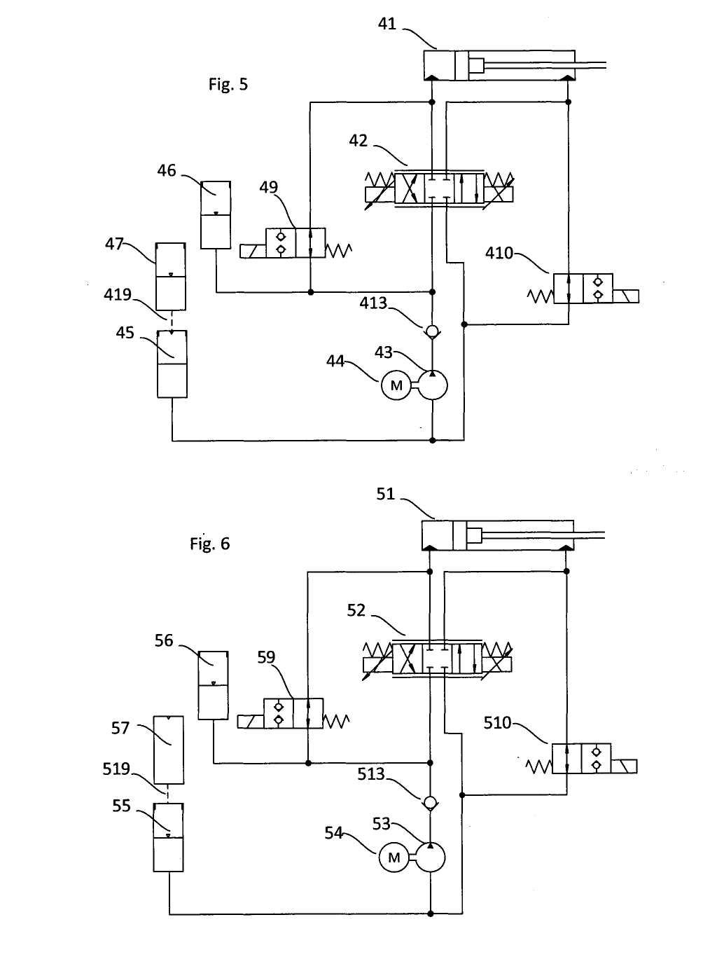

FIG. 5 shows a third schematic view of a hydraulic pitch system consisting of a pitch actuator 41, controlled by a hydraulic valve 42. The pressure and flow for control of the pitch system is delivered by the hydraulic pump 43, which is driven by the electrical motor 44. The hydraulic oil is stored in the pilot pressurized hydraulic reservoir 45. Energy for emergency stops is stored in the hydraulic accumulator 46 and lead into the pitch actuator by de-energization of valve 49. Valve 410 is used to lead the hydraulic oil from the rod side of the cylinder 1 into the pilot pressurized reservoir 5 during emergency stop. Valve 423 is a check valve. 419 illustrate the hydraulic pilot pressure line. In the schematic the line is drawn from the fluid side of a dedicated hydraulic accumulator, hydraulic accumulator 47. The pilot line pressure acts on the pilot area of the pilot pressurized reservoir ensuring a pressure higher than atmospheric pressure.

FIG. 6 shows a fourth schematic view of a hydraulic pitch system consisting of a pitch actuator 51, controlled by a hydraulic valve 52. The pressure and flow for control of the pitch system is delivered by the hydraulic pump 53, which is driven by the electrical motor 54. The hydraulic oil is stored in the pilot pressurized hydraulic reservoir 55. Energy for emergency stops is stored in the hydraulic accumulator 56 and lead into the pitch actuator by de-energization of valve 59. Valve 510 is used to lead the hydraulic oil from the rod side of the cylinder 1 into the pilot pressurized reservoir 5 during emergency stop. Valve 513 is a check valve 519 illustrates the pilot pressure line. In the schematic the line is drawn from a dedicated pressurized gas vessel 57. The pilot line pressure acts on the pilot area of the pilot pressurized reservoir ensuring a pressure higher than atmospheric pressure.

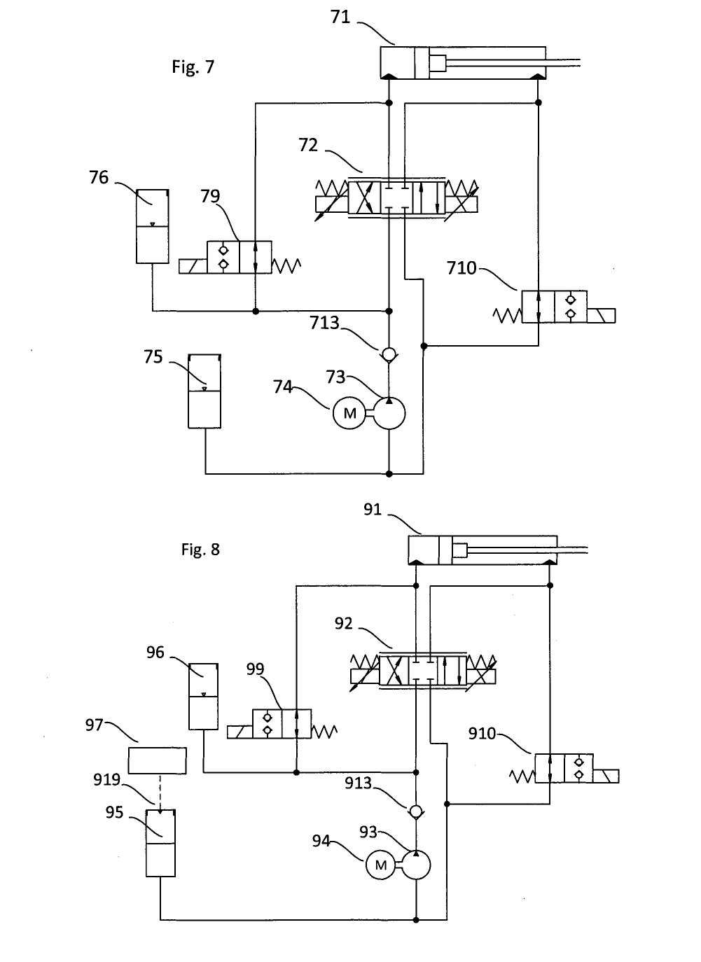

FIG. 7 shows a first schematic view of a hydraulic pitch system consisting of a pitch actuator 71, controlled by a hydraulic valve 72. The pressure and flow for control of the pitch system is delivered by the hydraulic pump 73, which is driven by the electrical motor 74. The hydraulic oil is stored in the pilot pressurized hydraulic reservoir 75. Energy for emergency stops is stored in the hydraulic accumulator 76 and lead into the pitch actuator by de-energization of valve 79. Valve 710 is used to lead the hydraulic oil from the rod side of the cylinder 1 into the pilot pressurized reservoir 5 during emergency stop. Valve 713 is a check valve. The pilot pressure for the pressurized hydraulic reservoir is included in the reservoir, meaning that the gas pressure acts on a piston area smaller than piston area on the fluid side, as illustrated in FIG. 2 and FIG. 3. The pilot pressure acts on the pilot area of the pilot pressurized reservoir ensuring a pressure higher than atmospheric pressure.

FIG. 8 shows a first schematic view of a hydraulic pitch system consisting of a pitch actuator 91, controlled by a hydraulic valve 92. The pressure and flow for control of the pitch system is delivered by the hydraulic pump 93, which is driven by the electrical motor 94. The hydraulic oil is stored in the pilot pressurized hydraulic reservoir 95. Energy for emergency stops is stored in the hydraulic accumulator 96 and lead into the pitch actuator by de-energization of valve 99. Valve 910 is used to lead the hydraulic oil from the rod side of the cylinder 1 into the pilot pressurized reservoir 5 during emergency stop. Valve 913 is a check valve. 919 illustrate the hydraulic pilot pressure line. In the schematic the line is drawn from a hydraulic auxiliary function 97. The auxiliary function could be a hydraulic brake function, hatch opening unit or similar system utilizing pressurized hydraulic fluid or gas. The pilot line pressure acts on the pilot area of the pilot pressurized reservoir ensuring a pressure higher than atmospheric pressure.

1. A fluid control system for operation of a pitch control system for wind turbines of the type comprising a pitch system driving at least one rotor blade, by at least one hydraulic actuator, wherein a hydraulic pump, of said fluid control system is supplied with hydraulic fluid from a hydraulic reservoir mounted on a rotating part of the wind turbine, wherein the hydraulic reservoir is a pilot pressurized hydraulic reservoir being pressurized by the pitch system itself, wherein said pilot pressurized hydraulic reservoir comprises a reservoir piston connected to a pilot piston through a rod and wherein the active reservoir piston area of said reservoir piston is larger than the active pilot piston area of said pilot piston.

2. A fluid control system according to claim 1, wherein the pilot pressure for pressurizing the pilot pressurized hydraulic reservoir is connected to the fluid side of a hydraulic accumulator.

3. A fluid control system according to claim 1, wherein the pilot pressure for pressurizing the pilot pressurized hydraulic reservoir is connected to the gas side of a hydraulic accumulator.

4. A fluid control system according to claim 1, wherein the pilot pressure for pressurizing the pilot pressurized hydraulic reservoir is connected to a pressurized gas vessel.

5. A fluid control system according to claim 1, wherein the pilot pressure for pressurizing the pilot pressurized hydraulic reservoir is connected to any pressurized system in the wind turbine.

6. A fluid control system according to claim 1, wherein the hydraulic actuator, the hydraulic pump and the pilot pressurized hydraulic reservoir are all accommodated in the hub of the wind turbine.

7. A fluid control system according to claim 1, wherein said pilot pressurized hydraulic reservoir is pressurized by the pitch system itself by utilization of a piston with a different area acting on the usable volume and the pilot volume, such that no external pressure control unit is needed.

8. A fluid control system according to claim 1, wherein said rotating part of the wind turbine is a hub or a blade of said wind turbine.

9. A fluid control system according to claim 1, wherein said hydraulic reservoir is placed in said rotating part of the wind turbine.

10. A fluid control system according to claim 1, wherein the active reservoir piston area of said reservoir piston is between 20 and 1000, preferably between 100 and 600, and most preferred between 150 and 400 times larger than the active pilot piston area of said pilot piston.

11. A fluid control system according to claim 1, wherein the active reservoir piston area is arranged on the side of said reservoir piston to which said rod is connected.

12. A fluid control system according to claim 1, wherein the active pilot piston area is arranged on the side of said pilot piston to which said rod is connected.

13. A wind power generator equipped with the fluid control system according to claim 1 for pitching a wind turbine rotor blade.
